(19) United States
(12) Patent Application Publication
(10) Pub. No.: US 2024/0280005 A1
(43) Pub. Date: Aug. 22, 2024

(54) Biometrically Activated Firing Sequence

(71) Applicant: Halliburton Energy Services, Inc., Houston, TX (US)

(72) Inventors: Nicholas Gerald Harrington, Alvarado, TX (US); Cameron Scott Badii, Alvarado, TX (US); Matthew Mlcak, Alvarado, TX (US); Christopher C. Hoelscher, Alvarado, TX (US)

(73) Assignee: Halliburton Energy Services, Inc., Houston, TX (US)

(21) Appl. No.: 18/110,422

(22) Filed: Feb. 16, 2023

(51) Int. Cl. E21B 43/1185; G06F 21/32; G06F 21/64

(52) U.S. Cl. CPC E21B 43/1185; G06F 21/32; G06F 21/64

(57) ABSTRACT

Systems and methods of the present disclosure relate to biometric access to perforating tools. A perforating system includes a firing panel in communication with a perforating apparatus and a biometric interface in communication with the firing panel. The perforating system is configured to control operation of the perforating apparatus upon authentication via the biometric interface.

### BACKGROUND

After drilling various sections of a wellbore that traverse a subterranean formation, individual metal tubulars may be secured together to form a casing string that is cemented within the wellbore. The casing string may provide a path for fluids to flow from producing subterranean intervals to the surface. To allow the fluids into the casing string, the casing string may be perforated.

Typically, the perforations may be created by detonating a series of charges within the casing string. Specifically, one or more charge carriers may be loaded with the charges. The charge carriers may then be secured within a tool string that is lowered into the casing string. Once the charge carriers are positioned at a desired depth, the charges may be detonated. Upon detonation, the charges may form jets that may cause perforations through the casing string, the cement, and a portion of the subterranean formation.

### BRIEF DESCRIPTION OF THE DRAWINGS

These drawings illustrate certain aspects of some examples of the present disclosure and should not be used to limit or define the disclosure.

FIG. 1 illustrates an operating environment for a perforating tool, in accordance with examples of the present disclosure;

FIGS. 2A and 2B illustrate different configurations for an explosive initiating system, in accordance with examples of the present disclosure;

FIGS. 3A and 3B illustrate different types of biometric interfaces, in accordance with examples of the present disclosure; and

FIG. 4 illustrates an operative sequence for the explosive initiating system, in accordance with examples of the present disclosure.

### DETAILED DESCRIPTION

The present disclosure generally relates to techniques for safety and security in the arming and firing sequence of jet perforating guns and other oil and gas well explosives. An electronic explosive firing panel system which relies on matching the user's biometrical information (e.g., fingerprints, iris scans, voice recognition, facial recognition, or other biometrics) to information stored in its database in order to conduct any or all of the following processes: authenticate the user; activate the panel or electronics within the explosive train; arm a firing system; and/or initiate an explosives train in a wellbore. Additionally, this system may use a pair of biometric features in order to meet requirements such as user “two hand” requirement for initiation.

The individual exclusivity provided by incorporating biometric data into the firing system software increases the control over activation, arming, and firing of explosives to those users physically present and pre-authorized to operate such systems. The risk of unintended or accidental initiation of firing panels is reduced because user access is better controlled. Additionally, security is improved because the use of initiating systems are limited to authorized users.

In particular examples, an explosive initiating system authenticates unique user biometrical information against a stored database of such information representing authorized users, in order to conduct any or all of the following actions: activate an explosive initiating control system, arm the initiating system, and/or send firing commands to the explosive train.

The explosive initiating system may include a firing panel configured to communicate with wellbore explosive components or associated controlling electronic switches, and various electronics used to confirm user input biometrics against a stored database of biometrics representing authorized users. A combination of at least three deliberate actions including biometrical inputs is used to fire the perforating guns. At least one action requires the use of two hands (e.g., two fingerprint sensors, or a fingerprint sensor and a spring-loaded switch that activates another form of required action).

The system may also use/store the biometric information as record of an electronic signature attesting to the consumption of explosives, to include batch traced or individually tracked and traced explosives. It may communicate this information back to a database storing such information either through a live connection at the time of firing or when connecting to a network at a later time of the user's choosing. The system may use the biometric information compared against the database of stored biometric information to unlock user specific privileges or features, such as the ability to initiate only certain types of systems, or to perform only communication checks and not a full firing sequence, or to perform initiating sequences only in a specified time window or at a specifically defined geographic location.

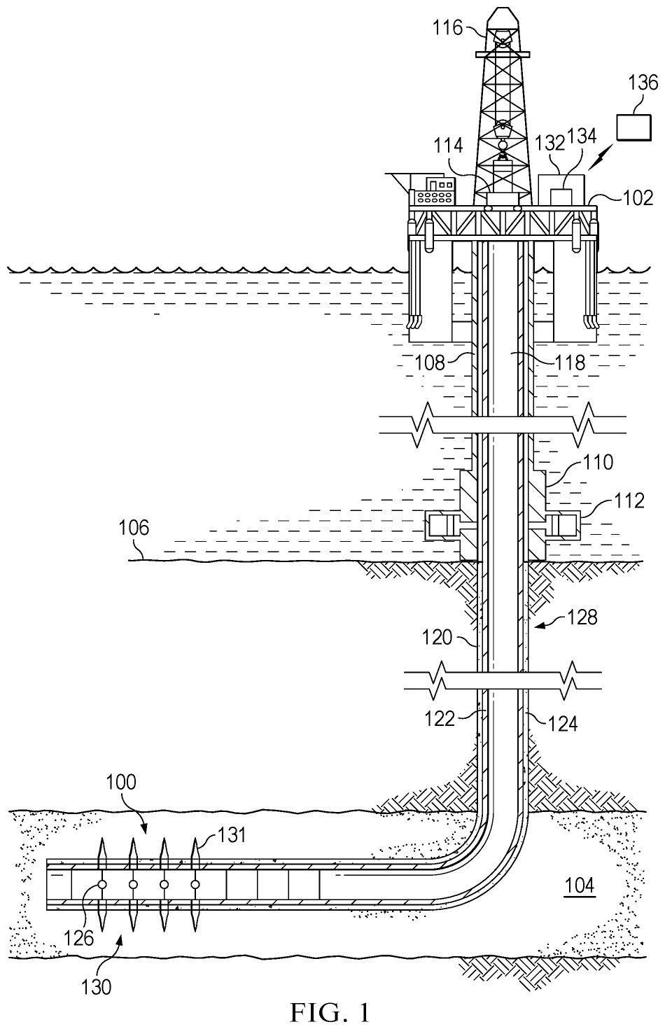

FIG. 1 illustrates an operating environment for a perforating tool 100, in accordance with examples of the present disclosure. A semi-submersible platform (“platform 102”) may be centered over a submerged oil and gas formation 104 that may be located below a sea floor 106. A subsea conduit 108 may extend from the platform 102 to a wellhead installation 110 which may include subsea blow-out preventers 112. The platform 102 may include a hoisting apparatus 114 and a derrick 116 for raising and lowering pipe strings such as a work string 118 which may include the perforating tool 100.

The work string 118 may also include a conveyance such as a wireline, slickline, coiled tubing, pipe, or downhole tractor, which may provide mechanical suspension, as well as electrical connectivity, for the perforating tool 100, for example. It should be understood that the configuration of the perforating tool 100 shown on FIG. 1 is merely illustrative and other configurations of the perforating tool 100 may be utilized with the present techniques. For example, although FIG. 1 depicts an offshore environment, systems and methods of the present disclosure may also be utilized onshore.

A wellbore 120 may extend through various earth strata including the formation 114. A casing string 122 may be cemented within the wellbore 120 by cement 124. The wellbore 120 may include an initial, generally vertical portion 128 and a lower, generally deviated portion 130 which is illustrated as being horizontal. It should be noted, however, by those skilled in the art that the perforating tool 100 may also be suited for use in other well configurations including, but not limited to, inclined wells, wells with restrictions, non-deviated wells, and/or multilateral wells, for example.

The perforating tool 100 may include various tools such as a plurality of perforating apparatuses or guns 126. To perforate the casing string 122, the perforating tool 100 may be lowered in the casing string 122 until the perforating guns 126 are properly positioned relative to the formation 104. Thereafter, in some examples, shaped charges (not shown) within the perforating guns 126 are detonated. Upon detonation, liners of the shaped charges may form a spaced series of perforations 131 extending outwardly through the casing string 122, the cement 124, and into the formation 104, thereby allowing fluid communication between the formation 104 and the wellbore 120.

An explosive initiating control system 132 may be used for biometric validation and control of the perforating tool 100. The explosive initiating control system 132 (e.g., a computer(s)) may include a control panel and a firing panel to activate, arm, and/or send firing commands to the perforating tool 100, upon biometric authentication. The explosive initiating control system 132 may also include a database 134, or may be in communication (e.g., wireless) with a database 136 (e.g., remote database). The explosive initiating control system 132 includes a biometric interface.

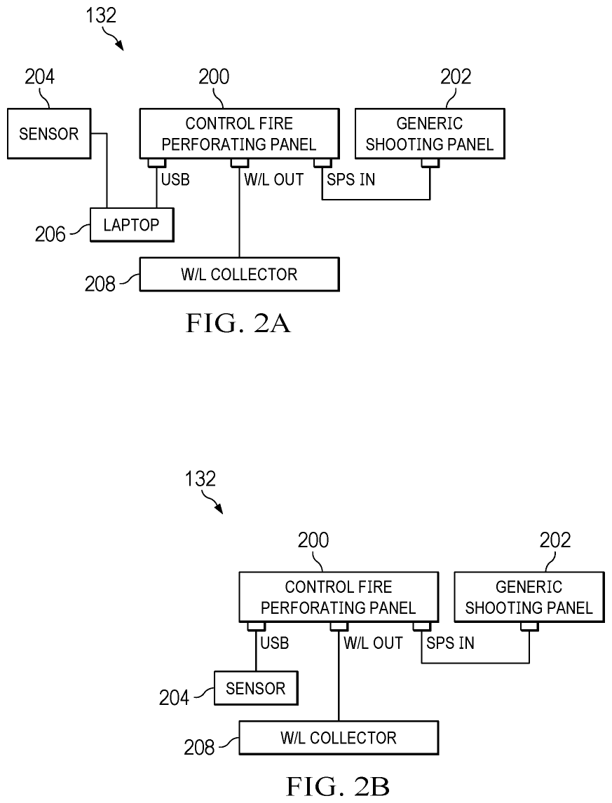

With additional reference to FIG. 2A, in some examples the explosive initiating control system 132 includes a control panel 200 in communication with a firing panel 202 to activate, arm, and/or send firing commands to the perforating tool, upon biometric authentication. The control panel 200 may also be in communication with a biometric interface 204 (e.g., a fingerprint scanner, iris scanner, voice recognition, facial recognition, and/or other biometrics) via a computer 206 (e.g., laptop). In some examples, the computer 206 may communicate with the databases (e.g., see FIG. 1). A wireline collector 208 may be in communication with the control panel 200.

The control panel 200 authenticates unique user biometrical information (via the biometric interfaces against a database (e.g., see FIG. 1)) that includes such information representing authorized users, in order to operate the perforating tool. The explosive initiating control system 132 may be in communication with the perforating tool (via the work string).

In some examples, the firing panel 202 may be configured to communicate with wellbore explosive components or associated controlling electronic switches (e.g., the perforating tool), and various electronics required to confirm user input biometrics against a database of biometrics representing authorized users. In some examples, a combination of at least three deliberate actions is used to fire the perforating gun(s). At least one action includes the use of two hands (e.g., a fingerprint sensor and a spring-loaded switch). A third action may include pressing a button or turning a knob on the firing panel 133 or another piece of associated equipment.

The explosive initiating control system 132 may also use the biometric information as record of an electronic signature attesting to the consumption of explosives, to include batch traced or individually tracked and traced explosives. The explosive initiating control system 132 may communicate this information back to the database(s) storing such information either through a real-time connection at the time of firing or when connecting to a network at a later time. The explosive initiating control system 132 may use the biometric information compared against the database(s) of stored biometric information to unlock user specific privileges or features, such as the ability to initiate only certain types of systems, or to perform only communication checks and not a full firing sequence, or to perform initiating sequences only in a specified time window or at a specifically defined geographic location. FIG. 2B illustrates an alternate configuration for the explosive initiating control system 132, in accordance with examples of the present disclosure. The biometric interface 204 may be directly coupled to the control panel 200 without an intermediary. The control panel 200 and/or the firing panel 202 may include a wireless transmission unit 210 (e.g., transmitter/receiver) to communicate with databases/servers.

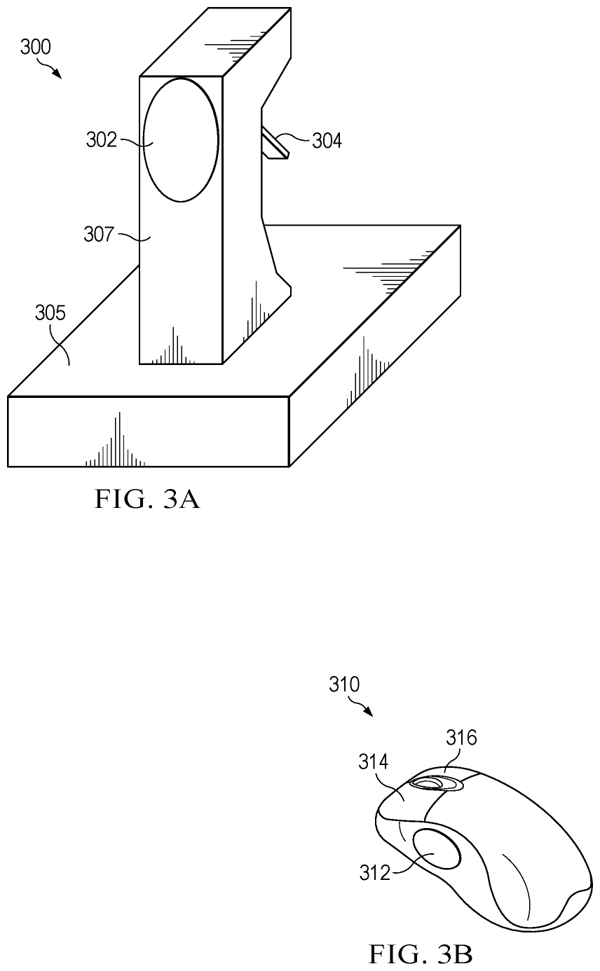

FIG. 3A illustrates an example of a biometric interface. A biometric interface 300 may resemble a joystick and include a fingerprint sensor 302 and a switch 304 for firing the perforating guns. The biometric interface 300 may include a base 305 with an extended member 307 that includes the fingerprint sensor 302 and the switch 304 for firing the perforating guns. FIG. 3B illustrates another example of a biometric interface. Another biometric interface may include a mouse 310 with a fingerprint sensor 312. A click of a button 314 or a button 316 may fire the perforating guns. In some examples, a handheld device (e.g., portable electronic device, keycard) may include a biometric sensor and/or biometric verification that is embedded in the handheld device. For example, a validated keycard may be used as a control panel key.

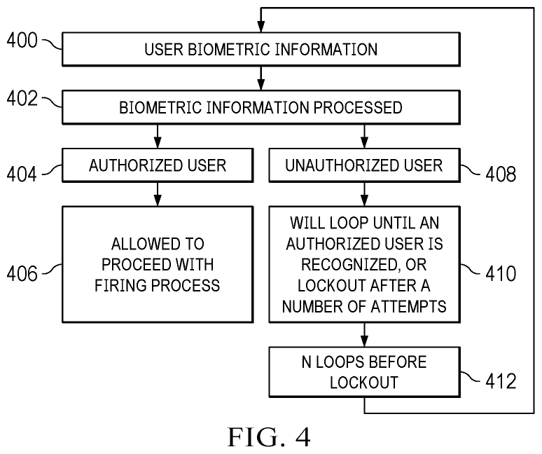

FIG. 4 illustrates an operative sequence for biometric validation for controlling a perforating tool, in accordance with particular examples of the present disclosure. At step 400, user biometric information is received by the explosive initiating control system (e.g., see FIG. 1). The explosive initiating control system may be used for biometric validation and control of the perforating tool. The explosive initiating control system may include a database, or may be in communication (e.g., wireless) with a database (e.g., see FIG. 1). The explosive initiating control system includes a biometric interface. The biometric interface may include a fingerprint scanner, iris scanner, voice recognition, facial recognition, or other biometrics.

At step 402, the biometric information is processed by the explosive initiating control system. The explosive initiating control system authenticates unique user biometrical information (via the biometric interface) against a database (e.g., see FIG. 1) storing such information representing authorized users, to allow operation of the perforating tool. At step 404, the authorization to control the perforating tool has been granted. At step 406, the user is allowed to proceed with the firing process. For example, the firing panel (e.g., see FIGS. 2A and 2B) may be configured to communicate with wellbore explosive components or associated in controlling electronic switches (e.g., the perforating tool), and various electronics required to confirm user input biometrics against a database of biometrics representing authorized users.

In some examples, a combination of at least three deliberate actions is used to fire the perforating gun(s). At least one action includes the use of two hands (e.g., a fingerprint sensor and a spring-loaded switch). A third action may include pressing a button or turning a knob on the firing panel or another piece of associated equipment.

The explosive initiating control system may also use the biometric information as record of an electronic signature attesting to the consumption of explosives, to include batch traced or individually tracked and traced explosives. The explosive initiating control system may communicate this information back to the database(s) storing such information either through a real-time connection at the time of firing or when connecting to a network at a later time.

The explosive initiating control system may use the biometric information compared against the database(s) of stored biometric information to unlock user specific privileges or features, such as the ability to initiate only certain types of systems, or to perform only communication checks and not a full firing sequence, or to perform initiating sequences only in a specified time window or at a specifically defined geographic location.

If the user is not authorized, then at step 408, the explosive initiating control system will prompt the user to enter verifiable biometric information again until lock-out which occurs after a number of unsuccessful attempts. For example, at step 410, the explosive initiating control system loops until an authorized user is recognized. At step 412, a number of loops occur before lockout.

Accordingly, the systems and methods of the present disclosure may allow for biometric validation for operation of downhole perforating tools. The systems and methods may include any of the various features disclosed herein, including one or more of the following statements.

Statement 1. A perforating system comprising: a firing panel in communication with a perforating apparatus; a biometric interface in communication with the firing panel; and wherein the perforating system is configured to control operation of the perforating apparatus upon authentication via the biometric interface.

Statement 2. The system of the statement 1, further including a database in communication with the firing panel.

Statement 3. The system of any one of the preceding statements, wherein the database includes a remote database.

Statement 4. The system of any one of the preceding statements, further including a control panel in communication with the firing panel.

Statement 5. The system of any one of the preceding statements, further including a database in communication with the firing panel, wherein the database includes biometric information.

Statement 6. The system of any one of the preceding statements, wherein the firing panel is configured to authenticate the biometric information.

Statement 7. The system of any one of the preceding statements, wherein the biometric information includes signatures for authorization.

Statement 8. The system of any one of the preceding statements, further comprising the perforating apparatus.

Statement 9. The system of any one of the preceding statements, wherein the firing panel is configured to communicate biometric information that includes batch traced or individually tracked and traced explosives for the perforating apparatus.

Statement 10. The system of any one of the preceding statements, wherein the perforating apparatus is disposed in a wellbore.

Statement 11. A method comprising: authorizing access to a perforating system comprising: a firing panel in communication with a perforating apparatus; a biometric interface in communication with the firing panel; and wherein the perforating system is configured to control operation of the perforating apparatus upon authorization via the biometric interface.

Statement 12. The method of the statement 11, further comprising disposing the perforating apparatus in a wellbore.

Statement 13. The method of any one of the statements 11 or 12, wherein the authorizing includes comparing biometric information.

Statement 14. The method of any one of the statements 11-13, further comprising storing the biometric information as a record of an electronic signature attesting to consumption of explosives.

Statement 15. The method of any one of the statements 11-14, further comprising firing the perforating apparatus upon authorization via the biometric interface.

Statement 16. The method of any one of the statements 11-15, wherein the authorizing includes communicating with a database.

Statement 17. The method of any one of the statements 11-16, wherein the database is remote.

Statement 18. The method of any one of the statements 11-17, further comprising tracing explosives for the perforating apparatus via the biometric interface.

Statement 19. The method of any one of the statements 11-18, wherein a database includes signatures for the tracing.

Statement 20. The method of any one of the statements 11-19, further comprising firing the perforating apparatus upon authorization via the biometric interface, wherein the biometric interface includes a switch or button to fire the perforating apparatus.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A perforating system comprising:
a firing panel in communication with a perforating apparatus;
a biometric interface comprising a pair of biometric features comprising an iris scanner in communication with the firing panel;
a database in communication with the firing panel to store biometric information to unlock user specific privileges only at a specifically defined geographic location; and
wherein the perforating system is configured to control operation of the perforating apparatus upon authentication via the biometric interface.

2. (canceled)

3. The perforating system of claim 2, wherein the database includes a remote database.

4. The perforating system of claim 1, further including a control panel in communication with the firing panel.

5. (canceled)

6. The perforating system of claim 5, wherein the firing panel is configured to authenticate the biometric information.

7. The perforating system of claim 6, wherein the biometric information includes signatures for authorization.

8. The perforating system of claim 1, further comprising the perforating apparatus.

9. The perforating system of claim 8, wherein the firing panel is configured to communicate biometric information that includes batch traced or individually tracked and traced explosives for the perforating apparatus.

10. The perforating system of claim 1, wherein the perforating apparatus is disposed in a wellbore.

11. A method comprising:
authorizing access to a perforating system comprising:
a firing panel in communication with a perforating apparatus;
a biometric interface in communication with the firing panel;
a database in communication with the firing panel to store biometric information to unlock user specific privileges only at a specifically defined geographic location; and
wherein the perforating system is configured to control operation of the perforating apparatus upon authorization via the biometric interface.

12. The method of claim 11, further comprising disposing the perforating apparatus in a wellbore.

13. The method of claim 11, wherein the authorizing includes comparing biometric information.

14. The method of claim 13, further comprising storing the biometric information as a record of an electronic signature attesting to consumption of explosives.

15. The method of claim 14, further comprising firing the perforating apparatus upon authorization via the biometric interface.

16. (canceled)

17. The method of claim 16, wherein the database is remote.

18. The method of claim 11, further comprising tracing explosives for the perforating apparatus via the biometric interface.

19. The method of claim 18, wherein a database includes signatures for the tracing.

20. The method of claim 11, further comprising firing the perforating apparatus upon authorization via the biometric interface, wherein the biometric interface includes a switch or button to fire the perforating apparatus.
